(19) United States
(12) Patent Application Publication
(10) Pub. No.: US 2024/0125170 A1
(43) Pub. Date: Apr. 18, 2024

(54) BULLET RESISTANT ROLLING OVERHEAD DOOR

(71) Applicant: Amos B. Glick, Gap, PA (US)

(72) Inventor: Amos B. Glick, Gap, PA (US)

(21) Appl. No.: 18/376,106

(22) Filed: Oct. 3, 2023

Related U.S. Application Data
(60) Provisional application No. 63/415,446, filed on Oct. 12, 2022.

(51) Int. Cl. E06B 9/15; F41H 5/24

(52) U.S. Cl. CPC E06B 9/15; F41H 5/24; E06B 2009/1544; E06B 2009/17069

(57) ABSTRACT

A bullet resistant and impact resistant overhead rolling door is created from a plurality of interconnected panel members formed from inner and outer shell members having interengagable barbs to secure the two shell members with one another when assembled. The two shell members create an internal cavity within the panel for housing ballistic material, such as a sheet of pressed ballistic material, insulating foam and/or a sheet of metal to increase ballistic resistance of the panel. A sheet of ballistic material can be secured between the interengaged barbs of adjacent panel members to serve as a hinge and permit pivotal movement therebetween. The shell members can be formed from metal with the ballistic material providing bullet resistant protection, but are preferably formed of 6063 aluminum to enhance the bullet resistance of the panel members.

### CROSS-REFERENCE TO RELATED APPLICATIONS

This application claims domestic priority on co-pending U.S. Provisional Patent Application Ser. No. 63/415,446, filed on Oct. 12, 2022, the content thereof being incorporated by reference herein.

### FIELD OF THE INVENTION

This invention relates generally to a rolling overhead door that can be used as a garage door, providing security for property and occupants behind the door and, more particularly, to a ballistic garage door configuration that can be rolled into a ball-like orientation to permit the garage door to be lowered quickly.

### BACKGROUND OF THE INVENTION

Ballistic barriers have been designed and provided to resist and/or prevent the passage of bullets fired at the barrier. Such ballistic barriers have been used at indoor shooting ranges, as security fences for residences and commercial property and other establishments, and as shields for individuals advancing under fire. Ballistic barriers are typically formed of bullet resistant metal and are heavy and difficult to use because of that weight. As security fence structures, the weight of the panels are difficult to install and to maintain.

In U.S. Pat. No. 1,899,735, granted on Jan. 22, 1932, to O. B. McClintock, a security barrier for bank tellers is disclosed in which the barrier is formed from a metal shell supporting bullet resistant glass and a complex structure to provide protection for a bank teller. A modular security fence is disclosed in U.S. Pat. No. 5,429,340, granted on Jul. 4, 1995, to Anthony M. Young, et al, in which the security fence is formed from overlapping panel modules. Each module is formed as an irregularly shaped open shell that interlocks with one or more adjoining modules or shells. Ballistic resistance is a result of opposing outer walls of the open shells when assembled together.

A ballistic barrier is disclosed in U.S. Pat. No. 8,001,880, granted to William C. White, et. al., on Aug. 23, 2011, wherein a lower barrier supports attack resistant panes extending upwardly from the barrier. The lower barrier provides protection from vehicle crashes, while the upper attack resistant panes are formed from material, such as plastic, acrylic and polycarbonates, among others, to resist penetration by bullets, particularly rounds fired by handguns. The ballistic wall structures disclosed in U.S. Patent Publication No. 2015/0354926, published on Dec. 10, 2015, by MGM Holdings, LLC, are designed for use in shooting ranges. The intent of this ballistic wall structure is to retain bullets within the wall structure. A ballistic curtain formed of ballistic rubber allows the passage of a bullet, while slowing the speed of the bullet so that the inner plate 54 stops the penetration of the bullet. The rubber curtain also prevents ricochets and fragments from passing back through the curtain.

Another ballistic barrier is disclosed in U.S. Pat. No. 10,012,479, granted to Michael Boviall on Jul. 3, 2018. This ballistic barrier is formed by a wall incorporating louvers or slats angled and overlapping to provide resistance to the passage of bullets by deflecting the path of the bullets downwardly to the ground. IN an alternative embodiment, the angled slats are backed by a backer plate that serves to further deflect the path of the bullets. A ballistic barrier designed to be portable in discrete panels and assembled in a selected location is disclosed in U.S. Pat. No. 10,281,245, granted on May 7, 2019, to Michael J. DeKort. Each panel can be connected to adjoining panels by hinges, and can, thereby, be folded for portability. Each panel is formed with a single pane of solid metal to provide bullet resistance.

Security doors have also been designed to resist bullet penetration, as can be seen in the security door configuration disclosed in U.S. Pat. No. 9,200,480, granted on Dec. 1, 2015 to Alan P. Deiler. In this Deiler patent, the security door is simply formed with an interior core of steel to resist bullet penetration. If a garage door were constructed according to this disclosed configuration, the garage door would have a tendency for bullets to ricochet from the door, rather than to absorb the energy carried by the bullet striking the garage door. The ricocheting bullet can provide a dangerous situation to other people and property near the garage door being struck by the bullet. As one skilled in the art would readily recognize, allowing a bullet to ricochet is not a desirable performance.

Accordingly, it would be desirable to provide a bullet resistant garage door structure that can absorb energy from a bullet striking the garage door without allowing the bullet to penetrate the structure of the garage door, at least be effective to resist the passage of bullets therethrough up to a predetermined caliber of weapon.

### SUMMARY OF THE INVENTION

It is an object of this invention to overcome the disadvantages of the known prior art devices by providing an overhead rolling door apparatus that is both bullet resistant and impact resistant.

It is another object of this invention to provide a quick drop bullet resistant overhead door.

It is a feature of this invention that the overhead rolling door is formed from a plurality of adjacent interconnected panel members having ballistic material placed therein to resist the passage of bullets through each said panel.

It is another feature of this invention that each panel is formed as two shell members that can be pressed together so that first and second barbs engage to secure the two shells together and form an internal cavity therebetween.

It is an advantage of this invention that the internal cavity can be filled with ballistic material and insulating foam before the two shell members are interengaged.

It is another advantage of this invention that a sheet of ballistic material can be secured between interengaged barbs and extend to adjacent panels for corresponding engagement between barbs of the adjacent panels to establish a hinge device between adjacent panels that permits pivotal movement therebetween.

It is still another object of this invention that the ballistic material captured within the internal cavity of each panel member is a sheet of pressed ballistic material.

It is still another feature of this invention that the two shell members are formed from metal.

It is yet another feature of this invention that the two shell members are formed from 6063 aluminum.

It is yet another object of this invention to provide a ballistic overhead rolling door having a plurality of ballistic panels, each panel including an outer shell having a generally planar front wall, top and bottom legs extending rearwardly from said front wall to define an internal cavity, each leg being formed with a front barb at the terminus thereof and an inner shell having a generally planar rear wall and two forwardly projecting inner barbs that are spaced to interfere with the two front barbs, respectively, said inner barbs being engagable with said front barbs to lock the inner and outer shells together in the formation of each said panel with each panel having at least one layer of ballistic material placed within the internal cavity.

It is still another feature of this invention that each panel further includes a sheet of ballistic material positioned on an inside part of the rear wall and captured between the inner and front barbs, the sheet of ballistic material also being captured by at least one set of engaged front and inner barbs on panels adjacent thereto such that the sheet of ballistic material becomes a hinge between adjacent panels to permit movement therebetween.

These and other objects, features and advantages are accomplished according to the instant invention by providing a bullet resistant and impact resistant overhead rolling door formed from a plurality of interconnected panel members formed from inner and outer shell members having interengagable barbs to secure the two shell members with one another when assembled. The two shell members create an internal cavity within the panel for housing ballistic material, such as a sheet of pressed ballistic material, insulating foam and/or a sheet of metal to increase ballistic resistance of the panel. A sheet of ballistic material can be secured between the interengaged barbs of adjacent panel members to serve as a hinge and permit pivotal movement therebetween. The shell members can be formed from metal with the ballistic material providing bullet resistant protection, but are preferably formed of 6063 aluminum to enhance the bullet resistance of the panel members.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a schematic front elevational view of a quick drop ballistic overhead rolling door configured as a garage door showing the Level 3 configuration in the upper portion of the schematic diagram and the Level 8 configuration in the lower portion of the schematic diagram;

FIG. 2 is an enlarged cross-sectional view of a portion of the garage door taken along lines 2-2 of FIG. 1 and forming a Level 3 bullet resistant configuration;

FIG. 3 is an exploded cross-sectional view of a single door panel depicted the two interlocking members that form the framework of the panel having a Level 3 resistance characteristic, along with the ballistic fiber member serving as a live hinge for adjacent panels;

FIG. 4 is a cross-sectional view of the Level 3 bullet resistant quick drop overhead door depicted in FIG. 2 showing the closed orientation of the entire door;

FIG. 5 is a cross-sectional view of the overhead door rolled up into a storage configuration to enable a quick drop response for the door;

FIG. 6 is an enlarged cross-sectional view of a portion of the garage door taken along lines 6-6 of FIG. 1 and forming a Level 8 bullet resistant configuration;

FIG. 7 is a cross-sectional view of the Level 8 bullet resistant quick drop garage door depicted in FIG. 2 showing the closed orientation of the entire door;

FIG. 8 is an exploded cross-sectional view of a single door panel depicted the two interlocking members that form the framework of the panel having a Level 8 resistance characteristic, along with the ballistic fiber member serving as a live hinge for adjacent panels;

FIG. 9 is an alternative embodiment of the garage door configuration as shown in FIG. 2 to provide a Level 3 or greater bullet resistant structure; and

FIG. 10 is an alternative embodiment of the garage door configuration as shown in FIG. 6 to provide a Level 8 or greater bullet resistant structure.

### DETAILED DESCRIPTION OF THE PREFERRED EMBODIMENT

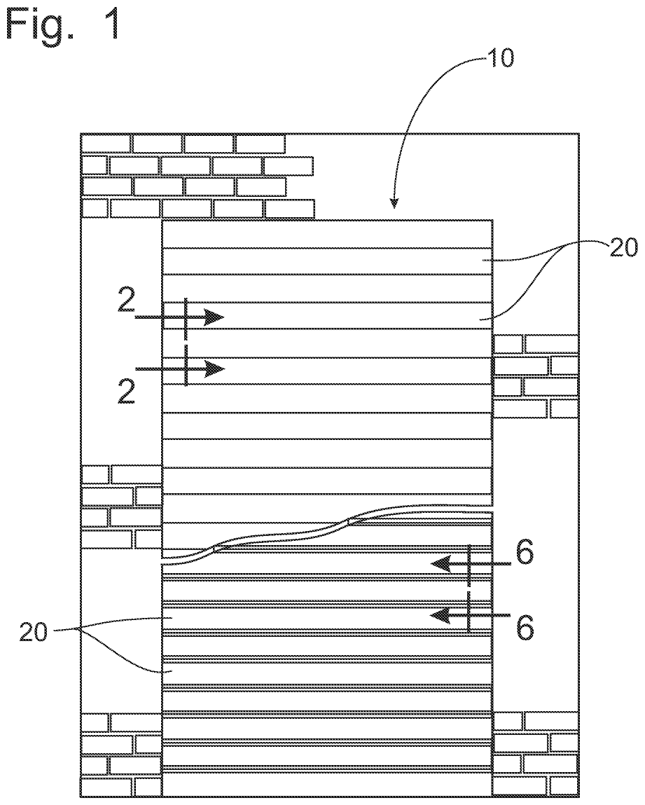

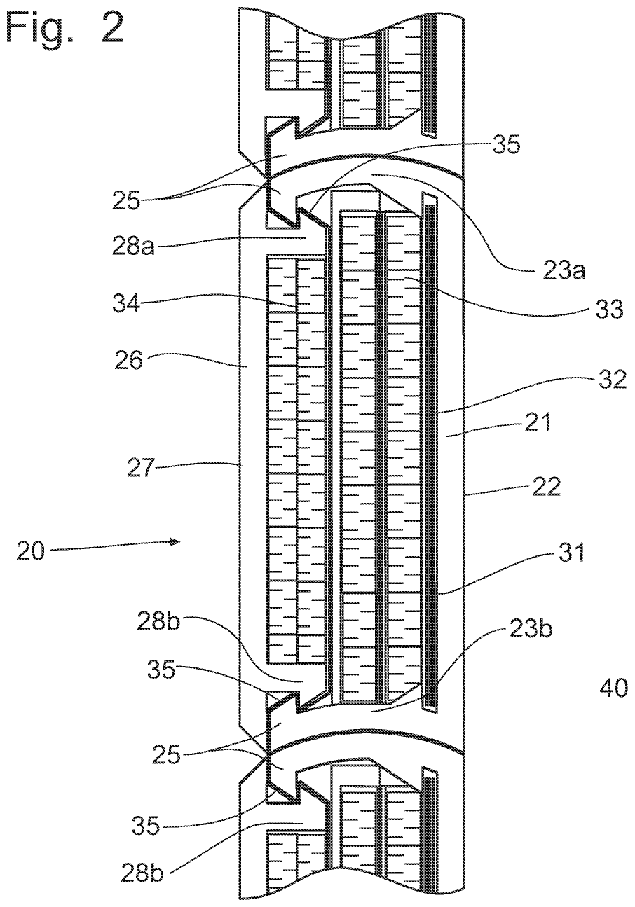

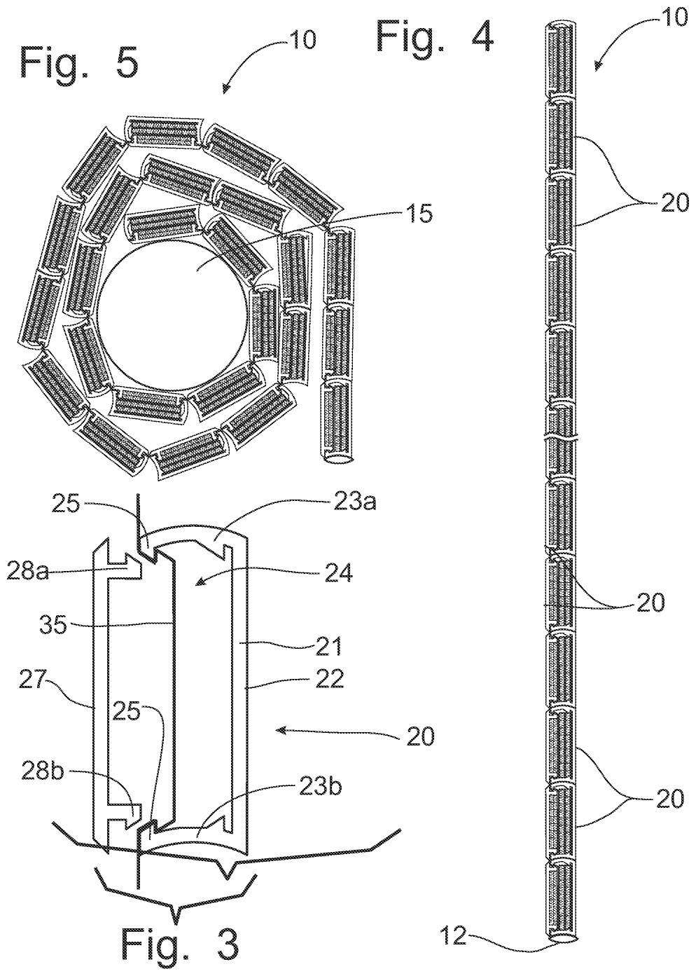

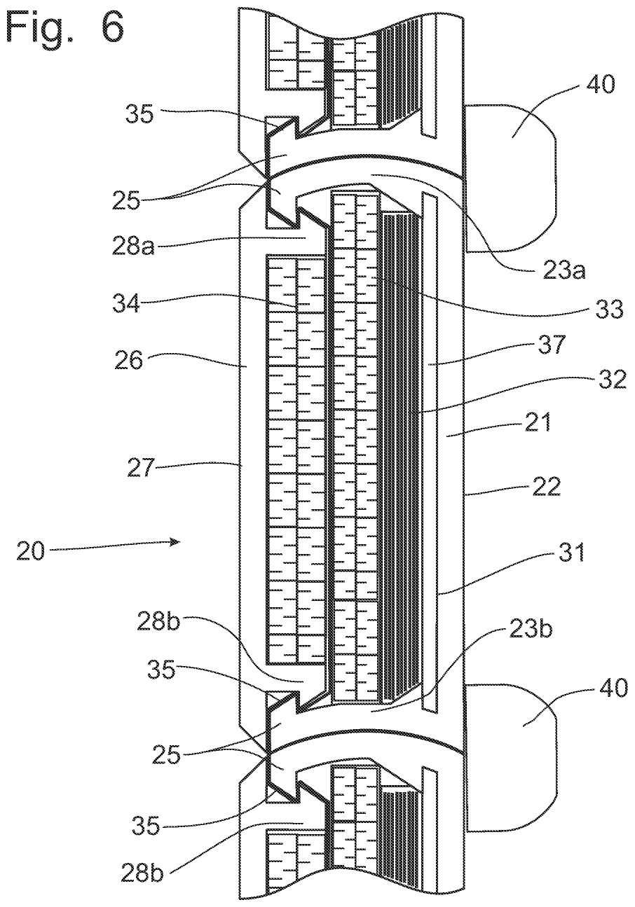

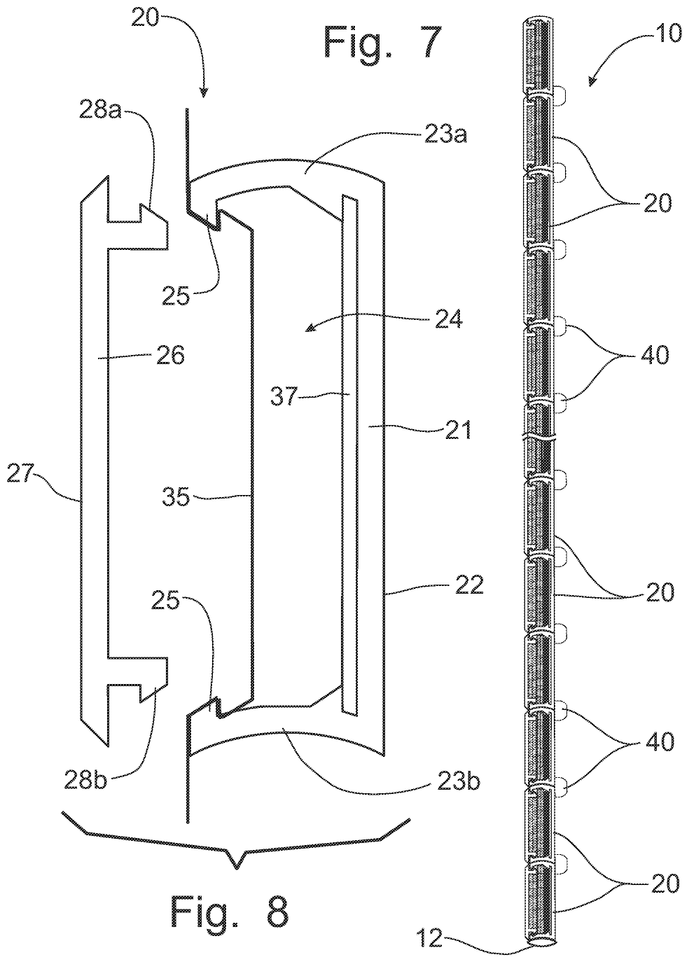

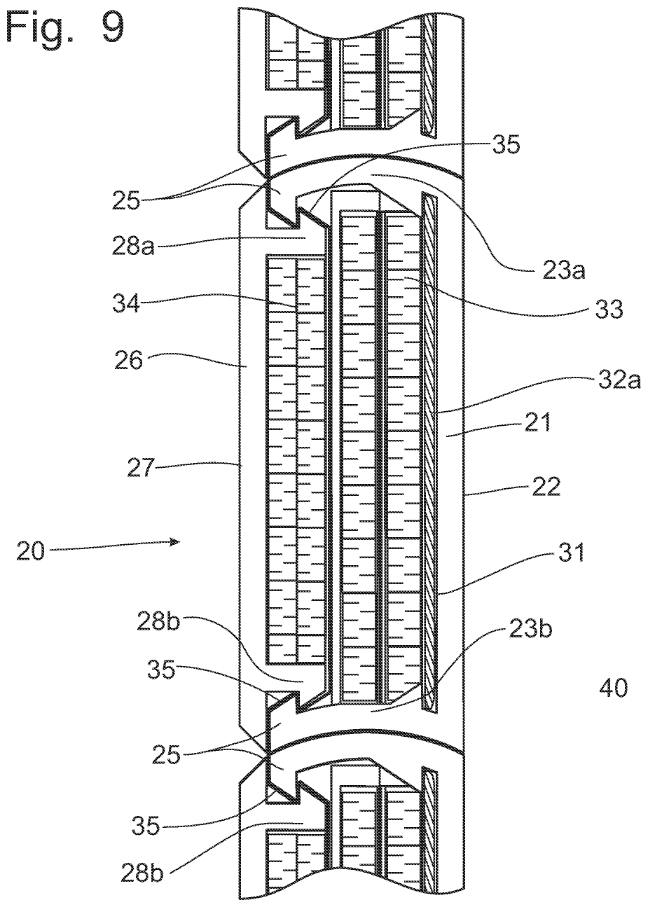

Referring to the drawings, two embodiments of a quick drop ballistic rolling overhead door incorporating the principles of the instant invention can be seen, FIGS. 2-5 depicting a Level 3 bullet resistant configuration and FIGS. 6-8 depicting a Level 8 bullet resistant configuration. The Level 8 configuration is effective to stop a higher caliber bullet than the Level 3 configuration. In general, the quick drop ballistic garage door 10 is formed from a plurality of horizontally extending panels 20 that are hinged together to allow the respective panels 20 to pivot relative to one another, as is depicted in FIG. 5, to permit the garage door to be quickly raised or lowered. Also, as is shown in FIG. 1, the rolling overhead door 10 will be formed with a conventional elastomeric seal 12 along the bottom edge to seal the rolling overhead door 10 against the lower surface of the frame structure (not shown) as is known in the art. The preferred embodiment of the rolling overhead door incorporating the principles of the instant invention is as a garage door 10, as depicted in FIG. 1, although other uses and configurations for this rolling overhead door 10 will be clear to one of ordinary skill in the art.

Each panel 20, for both the Level 3 and Level 8 configurations, is formed with two interlocking shells, an outer shell 21 and an inner shell 26. The primary differences between the Level 3 shells and the Level 8 shells are lateral size and the thickness of material. Each shell 21, 26 is preferably formed by 6063 aluminum, with the Level 3 and Level 8 shells being about 5/16 inch in thickness, although the Level 8 shells have an extra sheet of metal 37 in the front pocket 31 to bring the operative thickness of the front wall to ⅝ inch. Each outer shell 21 is formed with a generally planar front wall 22 with top and bottom legs 23a, 23b extending rearwardly from the front wall 22 to define an internal cavity 24. Each leg 23a, 23b has a barb 25 at the terminus thereof. The legs 23a, 23b are curved so as to be mating with the top leg 23a being convex and the bottom leg 23b being concave. This structural configuration helps to maintain a narrow opening between the panels 20 as the door is moving vertically. The inner shell 26 has a generally planar rear wall 27 and two forwardly projecting barbs 28a, 28b that are spaced to interfere with the two front barbs 25. The outer and inner shells 21, 26 can be pressed together, though because of the thickness of the aluminum in each of the shells 21, 26, the shells 21, 26 are pressed together with machinery and will not easily separate without an application of adequate pressure and the likely result of at least one of the barbs 25, 28 being broken.

Before the outer and inner shells 21, 26 of the Level 3 panels 20 are pressed together, a layer of multiple plies of ballistic material 32 is inserted into the front pocket 31 formed in the outer shell 21 and then two layers of insulating foam 33, which could optionally be separated by additional multiple plies of ballistic material (not shown). Further an additional layer of insulating foam 34 can be captured between the barbs 28a, 28b to fill the cavity 35 between the outer and inner shells 21, 26. Also before pressing the outer and inner shells 21, 26 together, a sheet of ballistic material 35 is pressed between the two shells 21, 26 and is secured between each of the two engaged barbs 25, 28 and the top and bottom of each panel 20. The sheet of ballistic material 35 is sufficiently large enough to cover the entire garage door 10 from top to bottom. The sheet of ballistic material 35 extending between adjacent panels 20 provides a hinge between the adjacent panels 20. Thus, the ballistic sheet 35 must be kept taut as the respective outer and inner shells 21, 26 are pressed together to form the garage door 10.

The configuration of the Level 8 garage door 10 is shown in FIGS. 6-8. While the general configuration is the same as described above with respect to the Level 3 garage door 10, extra ballistic material is positioned within the cavity 24 adjacent to the front pocket 31, replacing some of the insulating foam as shown above with respect to the Level 3 panels 20 and an extra metallic plate 37 is added into the front pocket 31, instead of ballistic material to increase the effective thickness of the front wall 22. The remainder of the cavity 24 can then be filled with appropriate layers of insulating foam 33, 34. As with the Level 3 panels 20, a sheet of ballistic material 35 is placed between the outer and inner shells 21, 26, sufficiently sized to cover the entire garage door 10 being formed so that the sheet of ballistic material 35 can be used as a hinge between adjacent panels 20. To provide a Level 8 ballistic protection at the joints between adjacent panels 20, particularly when the panels separate to move rearwardly into an open position or forwardly into a closed position, a supplemental metal baffle 40 that is secured to the front face 22 of the outer shell 21 above the joint and overlaps the joint between the adjacent panels 20.

As depicted schematically in FIG. 5, the panels 20 of the garage door 10 are wrapped around a cylinder 15 and around each other until the entire door 10 are raised above the door opening in the structure being protected by the ballistic garage door 10. Preferably, the cylinder 15 is spring-loaded when released to quickly lower the garage door 10 into a fully closed position, as is depicted in FIG. 1. The wrapping of the Level 3 garage door as depicted in FIG. 5 is similar to the wrapping of the Level 8 garage door 10, except that the supplemental baffles 40 increase the circumference of the wrapped panels 20.

The garage door 10, as described above, is formed of multiple hollow panels 20 filled with appropriate amounts of ballistic material 32 and insulating foam 33, 34 is designed to move quickly into a closed position in order to protect people and property within the closed structure. Therefore, this ballistic garage door is designed as a roll-up door to provide security and protection. Once closed, this garage door 10 will stop the penetration of the panels 20 by bullets from rifle attacks by active shooters and terrorist attacks. Once danger is identified, the roll-up garage door 10 will move rapidly from its rolled-up configuration to the fully closed configuration. Preferably, the closing of the garage door 10 can be accomplished remotely by personnel monitoring security situations to create a safe haven against such attacks. In addition to being ballistic rated, this garage door 10 design will be capable of being rated against forced entry and even explosion resistant at least to some degree.

The garage door 10 utilizes a sheet of ballistic material 35 as a hinge structure for movement between adjacent panels 20 without exposing a ballistic weakness due to non-ballistic hinges. The sheet of ballistic material 35 serving as hinges between adjacent panels 20 resists the passage of bullets and is capable of supporting the weight of the panels 20 forming the garage door 10. The outer and inner shells 21, 26 have a custom fit between corresponding barbs 25, 28 that can be pressed into engagement as a snap fit configuration. The curved top and bottom surfaces of the assembled panels 20 nest between adjacent structures to increase the ability to prevent the passage of bullets through the joint between adjacent panels 20.

The cavity within each of the panels 20 can be filled as needed with ballistic material 32 and insulating foam 33, 34 to enhance the ballistic performance of the panels 20. A bullet impacting the front face 22 of the outer shell 21 may puncture and pass through the front face 22, but will cause an expansion of the bullet upon engaging the ballistic material 32, which enhances the ability of the ballistic material 32 to stop the bullet from passing further through the panel 20. In the rare event that the bullet also passes through the ballistic material 32, the insulating foam 33, 34 will serve to dissipate the energy of the bullet so that the bullet will bounce off the rear panel wall 27 and be retained within the cavity 24 of the panel 20.

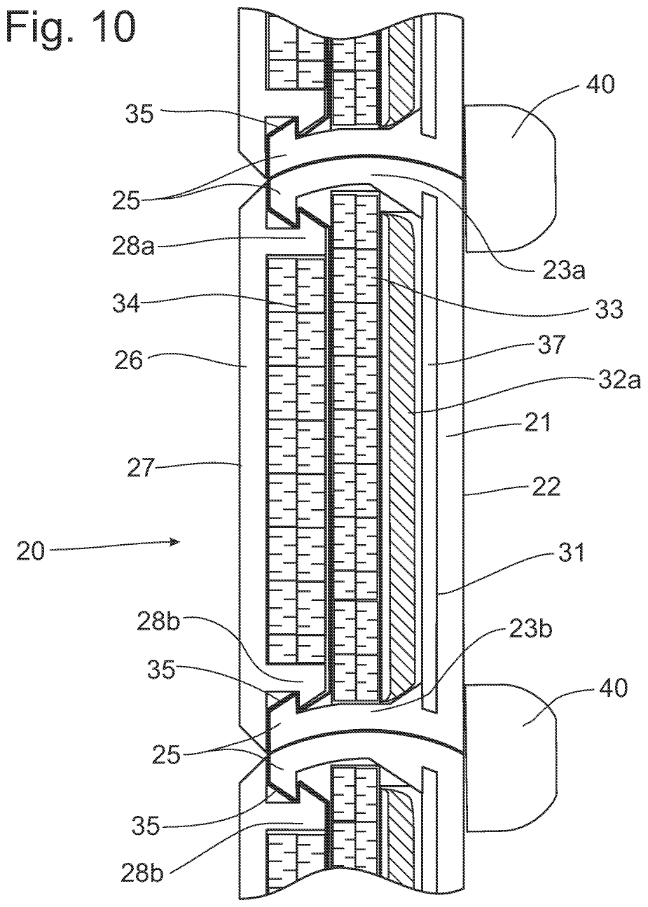

While the preferred embodiment of the above-described garage door panels 20 is 6063 aluminum, one of ordinary skill in the art will recognize that other forms of ballistic material can be used, including reinforced nylon, other metals besides aluminum, polymers, etc. Preferably the ballistic material can be molded as the shells 21, 26 or as the ballistic material within the panel cavities 24. Alternative embodiments of the Level 3 and Level 8 bullet resistant configuration quick drop garage doors are depicted in FIGS. 9 and 10, respectively. A recent evolution of ballistic material has produced pressed ballistic material which is generated by placing a desired number of layers of ballistic material and subjecting these layers to very high compressive forces to meld the layers of ballistic material together to form pressed ballistic material. This pressed ballistic material remains in a single sheet and retains flexibility. Furthermore, the bullet resistant characteristics of the pressed ballistic material are greater than the same number of layers of ballistic material before being pressed together.

Accordingly, the alternative configurations shown in FIGS. 9 and 10 replace the loose individual layers of ballistic material with a single layer of pressed ballistic material comprising a predetermined number of layers of ballistic material pressed together. One of ordinary skill in the art will recognize that the thickness of pressed ballistic material comprising 25 layers pressed together is smaller than the corresponding thickness of 25 individual layers of the same ballistic material. Accordingly, additional layers can be specified for the pressed ballistic material to provide an even higher level of bullet resistant protection for the same thickness of material utilized, with both improved performance of the pressed ballistic material and the extra possible layers of material.

Referring now to the alternative configuration shown in FIG. 9, the layers of ballistic material have been replaced with a single sheet of pressed ballistic material 32a that will provide the Level 3 bullet resistant protection. This sheet of ballistic material 32a will fit in the front pocket 31 of the outer shell 21 to provide Level 3 protection. Referring now to FIG. 10, the sheet of pressed ballistic material 32a for the Level 8 protection may be formed from 50-60 individual layers of ballistic material, and thus will have a thickness dimension greater than the Level 3 bullet resistant protection of the configuration shown in FIG. 9. Accordingly, this Level 8 sheet of pressed ballistic material 32a may have to be placed into the front portion of the cavity 24. Depending on the thickness of the sheet of pressed ballistic material 32a, a small section of insulating foam 33. 34 may be added to support the installation of the pressed sheet 32a.

According to the principles of the instant invention, quick drop doors can provide safety and security from ballistic attacks, bombs, and forced entry attempts. For certain historic buildings that cannot aesthetically afford the perceived eye-sore of new security doors, a quick drop rolling overhead door 10 could be installed in the ceiling, and be partially hidden until a time of deployment is necessary. For high security buildings, such as embassies, capitol buildings, etc., this door can provide an important barrier that saves lives and assets. Further use of the rolling overhead door would be found in schools where, in an instance of an armed attacker, quick drop rolling overhead door that had been proactively installed in strategic locations could be remotely closed by activating switches that initiate closure of the overhead rolling door for rapid deployment, thus securing full sections of the school from the imminent threat.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. For example, 6061 aluminum material can be substituted for the preferred 6063 aluminum material used in the interior and exterior aluminum panels 21-24; however, material thicknesses may require adjustment to maintain the desired bullet resistance capability.

Having thus described the invention, what is claimed is:

1. A ballistic overhead rolling door comprising:
a plurality of ballistic panels, each said panel including:
an outer shell having a generally planar front wall;
top and bottom legs extending rearwardly from said front wall to define an internal cavity, each said leg being formed with a front barb at the terminus thereof;
an inner shell having a generally planar rear wall and two forwardly projecting inner barbs that are spaced to interfere with the two front barbs, respectively, said inner barbs being engagable with said front barbs to lock said inner and outer shells together in the formation of each said panel;
each said panel having at least one layer of ballistic material placed within said internal cavity; and
a sheet of ballistic material positioned on an inside part of said rear wall and captured between said inner and front barbs, said sheet of ballistic material also being captured by at least one set of engaged front and inner barbs on panels adjacent thereto such that said sheet of ballistic material becomes a hinge between adjacent panels to permit movement therebetween.

2. The ballistic overhead rolling door of claim 1 wherein the top and bottom legs of each said outer shell are formed with corresponding arcs such that the top leg of one panel with mate with the bottom leg of an adjacent panel to minimize a horizontal projection of any gap between said adjacent panels when said panels rotate relative to one another.

3. The ballistic overhead rolling door of claim 1 wherein a layer of insulating foam is retained in said inner shell between said rear wall and said inner barbs.

4. The ballistic overhead rolling door of claim 1 wherein said outer shell is formed with a small front cavity and a larger second cavity.

5. The ballistic overhead rolling door of claim 4 wherein said front cavity holds a first section of said at least one layer of ballistic material.

6. The ballistic overhead rolling door of claim 4 wherein said front cavity holds a sheet of metal to increase the operative thickness of the front wall, said at least one layer of ballistic material being retained in said second cavity.

7. The ballistic overhead rolling door of claim 4 wherein said second cavity holds a layer of insulating foam.

8. The ballistic overhead rolling door of claim 5 wherein said outer shell, said inner shell and said sheet of metal within said front cavity are formed from 6063 aluminum.

9. The ballistic overhead rolling door of claim 1 wherein an uppermost panel is connected to a cylinder that is rotatable to wrap a majority of said panels thereabout in a circular manner to permit a rapid deployment of the overhead rolling door into a closed position.

10. The ballistic overhead rolling door of claim 1 further comprising:
a supplemental barrier affixed to a lower portion of said front wall and positioned to overlap a gap between the adjacent panel below said supplemental barrier.

11. A ballistic quick drop door comprising:
a plurality of ballistic panels, each said panel including:
outer and inner shells formed of metal, said shells being locked together in the formation of each said panel to form an internal cavity between a front wall and a rear wall;
at least one layer of ballistic material placed within said internal cavity;
at least one layer of insulating foam placed within said internal cavity; and
a sheet of ballistic material secured between said inner and outer shells and extending to adjacent panels to be also secured between inner and outer shells of said adjacent panels such that said sheet of ballistic material becomes a hinge between adjacent panels to permit movement therebetween.

12. The ballistic quick drop door of claim 11 wherein one of said inner and outer shells is formed with top and bottom horizontally oriented legs terminating with first barbs, the other of said inner and outer shells having opposing second barbs that are engagable with said first barbs to lock said inner and outer shells together.

13. The ballistic quick drop door of claim 12 wherein said sheet of ballistic material is captured between said corresponding engaged first and second barbs.

14. The ballistic quick drop door of claim 13 wherein said internal cavity includes a front cavity operable to retain a portion of said ballistic material or an extra sheet of metal to increase the thickness of said front wall.

15. The ballistic quick drop door of claim 14 wherein said internal cavity includes a second cavity rearwardly of said front cavity, said second cavity being operable to retain a portion of said ballistic material and a portion of said insulating foam.

16. The ballistic quick drop door of claim 12 wherein said top and bottom legs are formed with corresponding mating surfaces that relative movement without exposing a significant amount of gap between said adjacent panels when said panels rotate relative to one another.

17. The ballistic quick drop door of claim 16 wherein said corresponding mating surfaces are formed as corresponding arcs such that the top leg of one panel with mate with the bottom leg of an adjacent panel to minimize a horizontal projection of any gap between said adjacent panels when said panels rotate relative to one another.

18. A ballistic overhead rolling door comprising:
a plurality of ballistic panels, each said panel including:
an outer shell formed of metal and having a generally planar front wall;
top and bottom legs extending rearwardly from said front wall to define an internal cavity, each said leg being formed with a first barb at the terminus thereof;
an inner shell formed of metal and having a generally planar rear wall and two forwardly projecting inner barbs that are spaced to interfere with the two first barbs, respectively, said inner barbs being engagable with said first barbs to secure said inner and outer shells together in the formation of each said panel, thereby defining an internal cavity between said outer and inner shells, adjacent said panels being interconnected to permit pivotal movement therebetween;
each said panel having a sheet of pressed ballistic material placed within said internal cavity.

19. The ballistic overhead rolling door of claim 18 wherein a sheet of ballistic material is positioned on an inside part of said rear wall and captured between said inner and front barbs, said sheet of ballistic material extending to and also being captured by at least one set of engaged front and inner barbs on panels adjacent thereto such that said sheet of ballistic material serves as a hinge between adjacent panels to permit pivotal movement therebetween.

20. The ballistic quick drop door of claim 19 wherein said outer shell, said inner shell and said extra sheet of metal are formed from 6063 aluminum, said at least one layer of ballistic material placed into said internal cavity being a sheet of pressed ballistic material.
